(19) United States
(12) Patent Application Publication
(10) Pub. No.: US 2025/0238964 A1
(43) Pub. Date: Jul. 24, 2025

(54) METHOD OF VIDEO ENCODING AND SYSTEM FOR VIDEO ENCODING

(71) Applicant: GUANGDONG OPPO MOBILE TELECOMMUNICATIONS CORP., LTD., Dongguan (CN)

(72) Inventors: Cheolkon JUNG, Dongguan (CN); Shimin HUANG, Dongguan (CN)

(21) Appl. No.: 19/173,799

(22) Filed: Apr. 8, 2025

Related U.S. Application Data
(63) Continuation of application No. PCT/CN2022/136598, filed on Dec. 5, 2022.

(30) Foreign Application Priority Data
Oct. 13, 2022 (WO) PCT/CN2022/125213

(51) Int. Cl. G06T 9/00; G06T 3/4046

(52) U.S. Cl. CPC G06T 9/002; G06T 3/4046

(57) ABSTRACT

A method of video encoding is provided. The method may include receiving, by a head portion of a Lightweight Multi-level mixed Scale and Depth information with Attention mechanism (LMSDA) network, an input image. The method may include extracting, by the head portion of the LMSDA network, a first set of features from the input image. The method may include inputting, by a backbone portion of the LMSDA network, the first set of features through a plurality of LMSDA blocks (LMSDABs). The method may include generating, by the backbone portion of the LMSDA network, a second set of features based on an output of the LMSDABs. The method may include upsampling, by a reconstruction portion of the LMSDA network, the second set of features to generate an enhanced output image.

### CROSS REFERENCE TO RELATED APPLICATION(S)

This application is a continuation of International Application No. PCT/CN2022/136598, filed Dec. 5, 2022, which claims priority to International Application No. PCT/CN2022/125213, filed Oct. 13, 2022, the entire disclosures of which are incorporated herein by reference.

### BACKGROUND

Embodiments of the present disclosure relate to video encoding.

Digital video has become mainstream and is being used in a wide range of applications including digital television, video telephony, and teleconferencing. These digital video applications are feasible because of the advances in computing and communication technologies as well as efficient video coding techniques. Various video coding techniques may be used to compress video data, such that coding on the video data can be performed using one or more video coding standards. Exemplary video coding standards may include, but not limited to, versatile video coding (H.266/VVC), high-efficiency video coding (H.265/HEVC), advanced video coding (H.264/AVC), moving picture expert group (MPEG) coding, to name a few.

### SUMMARY

According to one aspect of the present disclosure, a method of video encoding is provided. The method may include receiving, by a head portion of a Lightweight Multi-level mixed Scale and Depth information with Attention mechanism (LMSDA) network, an input image. The method may include extracting, by the head portion of the LMSDA network, a first set of features from the input image. The method may include inputting, by a backbone portion of the LMSDA network, the first set of features through a plurality of LMSDA blocks (LMSDABs). The method may include generating, by the backbone portion of the LMSDA network, a second set of features based on an output of the LMSDABs. The method may include upsampling, by a reconstruction portion of the LMSDA network, the second set of features to generate an enhanced output image.

According to another aspect of the present disclosure, a system for video encoding is provided. The system may include a memory configured to store instructions. The system may include a processor coupled to the memory and configured to, upon executing the instructions, receive, by a head portion of an LMSDA network, an input image. The system may include a processor coupled to the memory and configured to, upon executing the instructions, extract, by the head portion of the LMSDA network, a first set of features from the input image. The system may include a processor coupled to the memory and configured to, upon executing the instructions, input, by a backbone portion of the LMSDA network, the first set of features through a plurality of LMSDABs. The system may include a processor coupled to the memory and configured to, upon executing the instructions, generate, by the backbone portion of the LMSDA network, a second set of features based on an output of the LMSDABs. The system may include a processor coupled to the memory and configured to, upon executing the instructions, upsample, by a reconstruction portion of the LMSDA network, the second set of features to generate an enhanced output image.

According to a further aspect of the present disclosure, a method of video encoding is provided. The method may include applying, by a feature extraction portion of an LMSDAB, a first convolutional layer with a first kernel size and a second convolutional layer of a second kernel size to a first set of features to generate a second set of features. The method may include combining, by the feature extraction portion of the LMSDAB, the second set of features on a channel dimension. The method may include generating, by the feature extraction portion of the LMSDAB, a fused feature map by fusing the second set of features combined on the channel dimension using a third convolutional layer of the first kernel size.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a block diagram of an exemplary encoding system, according to some embodiments of the present disclosure.

FIG. 2 illustrates a block diagram of an exemplary decoding system, according to some embodiments of the present disclosure.

FIG. 3 illustrates a detailed block diagram of an exemplary Lightweight Multi-level mixed Scale and Depth information with Attention mechanism (LMSDA) network for luma channel, according to some embodiments of the present disclosure.

FIG. 4 illustrates a detailed block diagram of an exemplary LMSDA network for a chroma channel, according to some embodiments of the present disclosure.

FIG. 5 illustrates a detailed block diagram of an exemplary LMSDA block (LMSDAB), according to some embodiments of the present disclosure.

FIG. 6A illustrates an example multi-scale feature extraction component.

FIG. 6B illustrates an exemplary multi-scale feature extraction component, according to some embodiments of the present disclosure.

FIG. 7A illustrates a first exemplary convolutional model, according to some aspects of the present disclosure.

FIG. 7B illustrates a second exemplary convolutional model, according to some aspects of the present disclosure.

FIG. 7C illustrates a third exemplary convolutional model, according to some aspects of the present disclosure.

FIG. 8 illustrates a detailed block diagram of an exemplary channel attention block (CAB), according to some aspects of the present disclosure.

FIG. 9 illustrates a detailed block diagram of an exemplary multi-scale spatial attention block (MSSAB), according to some aspects of the present disclosure.

FIG. 10 illustrates a detailed block diagram of an exemplary spatial attention block (SAB), according to some aspects of the present disclosure.

FIG. 11 illustrates a flow chart of a first exemplary method of video coding, according to some aspects of the present disclosure.

FIG. 12 illustrates a flow chart of a second exemplary method of video coding, according to some aspects of the present disclosure.

Embodiments of the present disclosure will be described with reference to the accompanying drawings.

### DETAILED DESCRIPTION

Although some configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure, or characteristic is described in connection with an embodiment, it would be within the knowledge of a person skilled in the pertinent art to effect such feature, structure, or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Various aspects of video coding systems will now be described with reference to various apparatus and methods. These apparatus and methods will be described in the following detailed description and illustrated in the accompanying drawings by various modules, components, circuits, steps, operations, processes, algorithms, etc. (collectively referred to as “elements”). These elements may be implemented using electronic hardware, firmware, computer software, or any combination thereof. Whether such elements are implemented as hardware, firmware, or software depends upon the particular application and design constraints imposed on the overall system.

The techniques described herein may be used for various video coding applications. As described herein, video coding includes both encoding and decoding a video. Encoding and decoding of a video can be performed by the unit of block. For example, an encoding/decoding process such as transform, quantization, prediction, in-loop filtering, reconstruction, or the like may be performed on a coding block, a transform block, or a prediction block. As described herein, a block to be encoded/decoded will be referred to as a “current block.” For example, the current block may represent a coding block, a transform block, or a prediction block according to a current encoding/decoding process. In addition, it is understood that the term “unit” used in the present disclosure indicates a basic unit for performing a specific encoding/decoding process, and the term “block” indicates a sample array of a predetermined size. Unless otherwise stated, the “block,” “unit,” and “component” may be used interchangeably.

The recent development of imaging and display technologies has led to the explosion of high-definition videos. Although the video coding technology has improved significantly, it remains challenging to transmit high-definition videos, especially when the bandwidth is limited. To cope with this problem, one existing strategy is resampling-based video coding. In resampling-based video coding, the video is first down-sampled before encoding, and then the decoded video is up-sampled to the same resolution as the original video. The AOMedia Video 1 (AV1) format includes a mode in which the frames are encoded at low-resolution and then up-sampled to the original resolution by bilinear or bicubic interpolation at the decoder. Versatile video coding (VVC) also supports a resampling-based coding scheme, named reference picture resampling (RPR), which performs temporal prediction between different resolutions. The advantages of RPR include, e.g., 1) reducing the video coding bitstream and the amount of network bandwidth used to transmit the encoded bitstream, and 2) reducing the video encoding and decoding latency. For example, after downsampling, the image resolution is smaller, thereby increasing the speed of the video coding/decoding (codec) process.

Although RPR provides certain advantages, image quality after upsampling still needs to be maintained. Unfortunately, the traditional interpolation methods have a limit in handling the complicated characteristics of videos.

For the neural network-based video coding (NNVC), the main concepts are as follows. The first uses the difference in the receptive field brought by different convolution kernel sizes, extracts different scale information from the input feature map, and uses it as a basic block of the operation. The network stacked by these basic blocks can indeed improve the performance of output. However, this may require an undesirable amount of network parameters as the basis. Moreover, while paying attention to the scale information, the layer depth information is often ignored in another direction. The second reduces the network parameters by separable convolutions, which include depth-wise separable convolutions and spatially separable convolutions. Separable convolutions may reduce the number of network parameters, but problems still exist. For instance, if the dimension of channels is not high, then using a rectified linear activation function (ReLU) as the activation function causes a loss of information in the depth-wise separable convolution. One existing solution performs standard convolutions before the depth-wise separable convolutions to increase their dimensionality.

For some video encoding techniques that are based on convolutional neural networks (CNNs), residual learning is utilized. If the network's learning ability is function W, the input of the network is ƒᵢₙ, the output is ƒₒᵤₜ represented as ƒₒᵤₜ=ƒᵢₙ+W(ƒᵢₙ). Compared to direct learning of the network on the whole image, the residual learning makes the network simpler by learning the residual between the input and the output. This simplification is achieved because the network learns more accurate mapping due to the residual connections. Even in the worst-case scenarios, the residual learning ensures that the output quality is not deteriorated, which makes the network learn faster and easier. Therefore, residual learning greatly reduces the complexity of the network learning, and thus it has been commonly used. However, since the input and output sizes are different in the super-resolution (SR) task, residual learning cannot be directly applied. Therefore, residual learning can only be used in the feature space due to the consistency of its dimensions.

Up to the present, CNN and generative adversarial network (GAN) have been commonly used for network learning. CNN uses L1 or L2 loss to make the output gradually close to the ground truth as the network converges. For the SR-task, the high-resolution map output by the network is required to be consistent with the ground truth. The L1 or L2 loss is a loss function that is compared at the pixel level. The L1 loss calculates the sum of the absolute values of the difference between the output and the ground truth, while the L2 loss calculates the sum of the squares of the difference between the output and the ground truth. Although a CNN that uses an L1 or L2 loss removes blocking artifacts and noise in the input image, it cannot recover textures lost in the input image. GAN may improve the quality of perception to generate plausible results. The GAN-based method may achieve a desirable texture and detail information recovery, such as the method implemented by a deep convolutional generative adversarial network (DCGAN). Through adversarial learning of the generator and discriminator, a GAN can generate the texture information lost in the input. However, due to the randomness of the texture information generated by the GAN, it may not be consistent with the ground truth. Although rich textures may be generated from the input image, these textures are far from the ground truth. In other words, although the GAN-based method improves the perceived quality and visual effect, it increases the difference between the output and the ground truth and thus, reduces the performance in the peak-signal-to-noise ratio (PSNR).

To overcome these and other challenges, the present disclosure provides an exemplary LMSDA network that includes a CNN for RPR-based SR in VVC. The exemplary LMSDA network is designed for residual learning to reduce the network complexity and improve the learning ability. The LMSDA network's basic block, which is combined with an attention mechanism, is referred to as an “LMSDAB.” Using the LMSDAB, the LMSDA network may extract multi-scale and depth information of image features. For instance, multi-scale information may be extracted by convolutional kernels of different sizes, while depth information may be extracted from different depths of the network. For LMSDAB, sharing the convolutional layers is adopted to greatly reduce the number of network parameters.

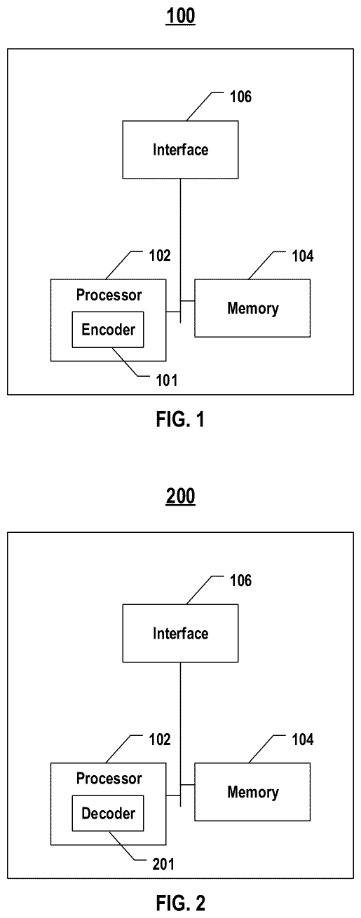

For instance, the exemplary LMSDA network effectively extracts low-level features in a U-Net structure by stacking LMSDABs, and transfers the low-level features in the U-Net structure to the high-level feature extraction module through U-Net connections. High-level features may include global semantic information, while low-level features include local detail information. Thus, the U-Net connections further reuse low-level features while restoring local details. After extracting multi-scale and layer-wise information, the LMSDAB may implement an attention mechanism to enhance the important information, while at the same time, weakening the unimportant information. Moreover, the present disclosure provides an exemplary multi-scale attention mechanism, which combines the multi-scale spatial attention maps obtained through a convolution after performing a spatial attention on each scale information. Then, channel attention may be combined to enhance the feature map extracted by the LMSDAB in the spatial and channel domains. Additional details of the exemplary LMSDA network and its multi-scale attention mechanism are provided below in connection with FIGS. 1-12.

FIG. 1 illustrates a block diagram of an exemplary encoding system 100, according to some embodiments of the present disclosure. FIG. 2 illustrates a block diagram of an exemplary decoding system 200, according to some embodiments of the present disclosure. Each system 100 or 200 may be applied or integrated into various systems and apparatus capable of data processing, such as computers and wireless communication devices. For example, system 100 or 200 may be the entirety or part of a mobile phone, a desktop computer, a laptop computer, a tablet, a vehicle computer, a gaming console, a printer, a positioning device, a wearable electronic device, a smart sensor, a virtual reality (VR) device, an argument reality (AR) device, or any other suitable electronic devices having data processing capability. As shown in FIGS. 1 and 2, system 100 or 200 may include a processor 102, a memory 104, and an interface 106. These components are shown as connected to one another by a bus, but other connection types are also permitted. It is understood that system 100 or 200 may include any other suitable components for performing functions described here.

Processor 102 may include microprocessors, such as graphic processing unit (GPU), image signal processor (ISP), central processing unit (CPU), digital signal processor (DSP), tensor processing unit (TPU), vision processing unit (VPU), neural processing unit (NPU), synergistic processing unit (SPU), or physics processing unit (PPU), microcontroller units (MCUs), application-specific integrated circuits (ASICs), field-programmable gate arrays (FPGAs), programmable logic devices (PLDs), state machines, gated logic, discrete hardware circuits, and other suitable hardware configured to perform the various functions described throughout the present disclosure. Although only one processor is shown in FIGS. 1 and 2, it is understood that multiple processors can be included. Processor 102 may be a hardware device having one or more processing cores. Processor 102 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. Software can include computer instructions written in an interpreted language, a compiled language, or machine code. Other techniques for instructing hardware are also permitted under the broad category of software.

Memory 104 can broadly include both memory (a.k.a, primary/system memory) and storage (a.k.a., secondary memory). For example, memory 104 may include random-access memory (RAM), read-only memory (ROM), static RAM (SRAM), dynamic RAM (DRAM), ferro-electric RAM (FRAM), electrically erasable programmable ROM (EEPROM), compact disc read-only memory (CD-ROM) or other optical disk storage, hard disk drive (HDD), such as magnetic disk storage or other magnetic storage devices, Flash drive, solid-state drive (SSD), or any other medium that can be used to carry or store desired program code in the form of instructions that can be accessed and executed by processor 102. Broadly, memory 104 may be embodied by any computer-readable medium, such as a non-transitory computer-readable medium. Although only one memory is shown in FIGS. 1 and 2, it is understood that multiple memories can be included.

Interface 106 can broadly include a data interface and a communication interface that is configured to receive and transmit a signal in a process of receiving and transmitting information with other external network elements. For example, interface 106 may include input/output (I/O) devices and wired or wireless transceivers. Although only one interface is shown in FIGS. 1 and 2, it is understood that multiple interfaces can be included.

Processor 102, memory 104, and interface 106 may be implemented in various forms in system 100 or 200 for performing video coding functions. In some embodiments, processor 102, memory 104, and interface 106 of system 100 or 200 are implemented (e.g., integrated) on one or more system-on-chips (SoCs). In one example, processor 102, memory 104, and interface 106 may be integrated on an application processor (AP) SoC that handles application processing in an operating system (OS) environment, including running video encoding and decoding applications. In another example, processor 102, memory 104, and interface 106 may be integrated on a specialized processor chip for video coding, such as a GPU or ISP chip dedicated to image and video processing in a real-time operating system (RTOS).

As shown in FIG. 1, in encoding system 100, processor 102 may include one or more modules, such as an encoder 101 (also referred to herein as a “pre-processing network”). Although FIG. 1 shows that encoder 101 is within one processor 102, it is understood that encoder 101 may include one or more sub-modules that can be implemented on different processors located closely or remotely with each other. Encoder 101 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to video encoding, such as picture partitioning, inter prediction, intra prediction, transformation, quantization, filtering, entropy encoding, etc., as described below in detail.

Similarly, as shown in FIG. 2, in decoding system 200, processor 102 may include one or more modules, such as a decoder 201 (also referred to herein as a “post-processing network”). Although FIG. 2 shows that decoder 201 is within one processor 102, it is understood that decoder 201 may include one or more sub-modules that can be implemented on different processors located closely or remotely with each other. Decoder 201 (and any corresponding sub-modules or sub-units) can be hardware units (e.g., portions of an integrated circuit) of processor 102 designed for use with other components or software units implemented by processor 102 through executing at least part of a program, i.e., instructions. The instructions of the program may be stored on a computer-readable medium, such as memory 104, and when executed by processor 102, it may perform a process having one or more functions related to video decoding, such as entropy decoding, inverse quantization, inverse transformation, inter prediction, intra prediction, filtering, as described below in detail.

Referring back to FIG. 1, for RPR functionality, encoder 101 first downsamples the current video frame to reduce the transmission bitstream in the limited bandwidth. When the current frame is restored by decoder 201, the current frame is upsampled to its original resolution. To address the complicated characteristics of videos with a high degree of accuracy, encoder 101 may include an exemplary LMSDA network (e.g., an SR neural network), which replaces the upsampling algorithm in the RPR configuration. The exemplary LMSDA network of encoder 101 employs residual learning to reduce network learning complexity and improve performance. Residual learning recovers image details with a high degree of accuracy because the image details are contained in the residuals.

The LMSDA network's basic block is the LMSDAB, which applies convolutional kernels of different sizes and convolutional layer depths, while using fewer parameters. The LMSDAB extracts multi-scale information and depth information, which is combined with an attention mechanism to complete feature extraction. Since residual learning cannot be directly applied to SR, the LMSDA network first upsamples the input image to the same resolution as the output by interpolation. Then, the LMSDA network enhances the image quality by residual learning. In some embodiments, the LMSDAB uses 1×1 and 3×3 convolutional operators, while using shared convolutional layers to reduce the number of parameters. This may enable the LMSDAB to extract the larger scale features to obtain multi-scale information.

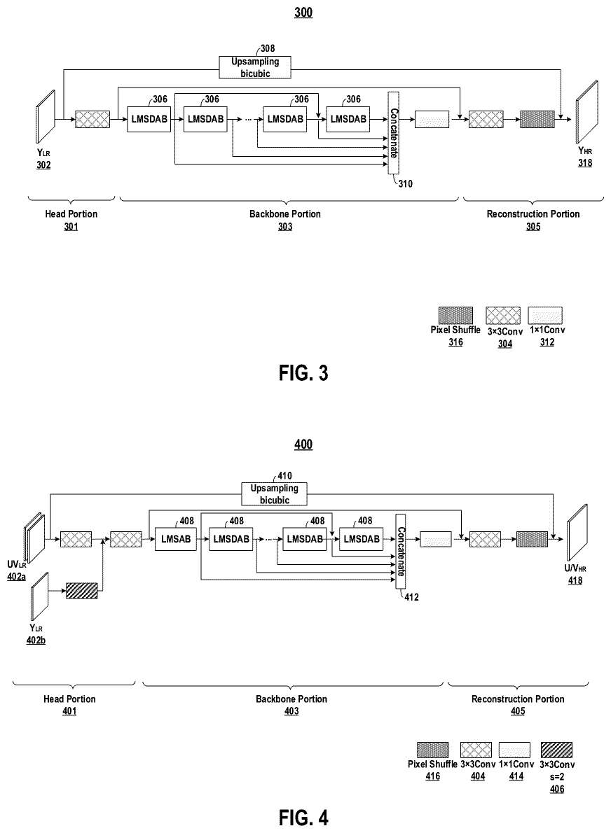

At the same time, the layer depth information is also captured by sharing the convolutional layers. The LMSDA network enhances image features through a multi-scale spatial attention block (MSSAB) and channel attention block (CAB). The MSSAB and CAB learn the attention map in the spatial and channel domains, respectively, and apply attention operations to these dimensions of the acquired feature map to enhance important spatial and channel information. Additional details of the LMSDA network and LMSDAB are provided below in connection with FIGS. 3-12.

FIG. 3 illustrates a detailed block diagram of an exemplary LMSDA network 300 (referred to hereinafter as “LMSDA network 300”) for a luma channel (e.g., the Y channel), according to some embodiments of the present disclosure. As shown in FIG. 3, LMSDA network 300 includes, e.g., a head portion 301, a backbone portion 303, and a reconstruction portion 305.

Head portion 301 includes a convolutional layer 304, which is used to extract the shallow features of the input image. Convolutional layer 304 in head portion 301 is followed by a rectified linear activation function (ReLU) activation function (not shown). Given input Y_{LR}, through the head network ψ, the shallow feature ƒ₀ is obtained according to expression (1).

$${f}_{0} = ψ ( {Y}_{L R} ) . \qquad ( 1 )$$

Backbone portion 303 may include M LMSDABs 306. Backbone portion 303 uses ƒ₀ as input. A concatenator 310 concatenates the LMSDAB outputs, and finally reduces the number of channels by a 1×1 convolutional layer 312 to obtain ƒ_{ft} according to expression (3). ƒ_{ft} may be used as the input into reconstruction portion 305. To take advantage of low-level features, backbone portion 303 uses the connection method in the U-Net to add the output of the i-th and M-i-th LMSDAB ƒᵢ and ƒ_{M-i} as the input of ω_{M-i+1} according to expression (2).

$${f}_{M - i + 1} = {ω}_{M - i + 1} ( {f}_{i} + {f}_{M - i} ) 0 < i < M / 2 ; and \qquad ( 2 )$$

$${f}_{f t} = Conv ( C [ {ω}_{M} , {ω}_{M - 1} , … {ω}_{1} ( {f}_{0} ) ] ) + {f}_{0} , \qquad ( 3 )$$

where ωᵢ represents the M-th LMSDAB 306, C[.] represents the channel concatenation, and ƒᵢ represents the output of the M-th LMSDAB 306. Channel concatenation may refer to stacking features in the channel dimension. For instance, assume the dimensions of the two feature maps are B×C1×H×W and B×C2×H×W. After concatenation, the dimensions become B×(C1+C2)×H×W.

Reconstruction portion 305 (e.g., the upsampling network) includes one convolutional layer 304 and a pixel shuffle layer 316. The upsampling network may be represented according to expression (4).

$${Y}_{HR} = PS ( Conv ( {f}_{f t} ) ) + {Y}_{LR} , \qquad ( 4 )$$

where Y_{HR} is the upsampled image, PS is the pixel shuffle layer, Conv represents the convolutional layers, and ReLU activation function is not used in the upsampling part.

In addition to the three parts, the input image may be directly added to the output by upsampling the input via upsampling bicubic component 308. In this way, LMSDA network 300 only needs to learn the global residual information to enhance the quality of the output image 318, which reduces the training and computational complexity.

FIG. 4 illustrates a detailed block diagram of an exemplary LMSDA network 400 (referred to hereinafter as “LMSDA network 400”) for a chroma channel, according to some embodiments of the present disclosure. As shown in FIG. 4, LMSDA network 400 includes, e.g., a head portion 401, a backbone portion 403, and a reconstruction portion 405.

The inputs to LMSDA network 400 include channels, e.g., namely Y, U, and V. Because the chroma components contain less information and easily lose key information after compression, it is difficult for a CNN to learn the information that has been lost in the input. Therefore, relying only on a single U or V channel for SR may not perform well. Therefore, all three Y, U, and V channels are used to solve the problem of insufficient information of a single chroma component by LMSDA network 400. The luma channel (e.g., the Y channel) may carry more information than the chroma channels (e.g., the U and V channels), and thus, the luma channel guides the SR of the chroma channels.

As shown in FIG. 4, head portion 401 may include two 3×3 convolutional layers 404, one of which is used for downsampling, while the other is used to extract shallow features after mixing the chroma component 402a and the luma component 402b. The U channel and the V channel may be concatenated together to generate the chroma component 402a. The size of the luma channel (e.g., Y channel) is twice that of the chroma channel (e.g., U/V channel). Thus, the Y channel needs to be downsampled first. To that end, a 3×3 convolutional layer 406 with stride 2 may be used for downsampling. The output ƒ₀ of the head portion 401 may be represented by expression (5).

$${f}_{0} = C o n v ( C o n v ( C [ {U}_{L R} , {V}_{L R} ] ) + d C o nv ( {Y}_{L R} ) ) , \qquad ( 5 )$$

where ƒ₀ represents the output of the head, dConv( ) represents the downsampling convolutional layer 406, and Conv( ) represents convolutional layer 404 with stride 1.

Backbone portion 403 may include M LMSDABs 408. Backbone portion 403 uses ƒ₀ as input. A concatenator 412 concatenates the LMSDAB outputs, and finally reduces the number of channels by a 1×1 convolutional layer 414 to obtain ƒ_{ft} according to expression (3), shown above. ƒ_{ft} may be used as the input into reconstruction portion 405.

Reconstruction portion 405 (e.g., the upsampling network) includes a convolutional layer 404 and a pixel shuffle layer 416. In addition to the three parts, the input image may be directed added to the output by upsampling the input via upsampling bicubic component 410. In this way, LMSDA network 400 only needs to learn the global residual information to enhance the quality of the output image 418, which reduces the training and computational complexity.

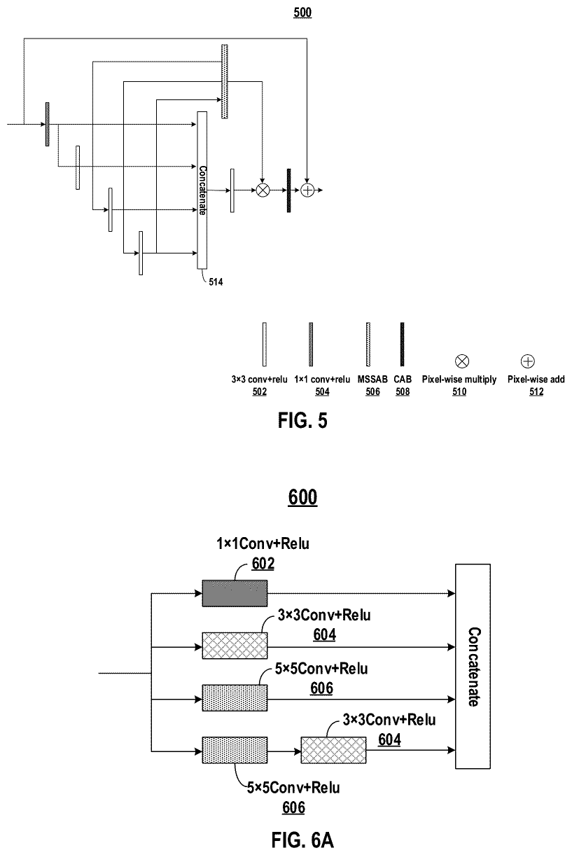

FIG. 5 illustrates a detailed block diagram of an exemplary LMSDAB 500 (referred to hereinafter as “LMSDAB 500”), according to some embodiments of the present disclosure.

Referring to FIG. 5, LMSDAB 500 may extract multi-scale and depth features from a large receptive field using stacked convolutional layers 502, 504. Important spatial and channel information may be extracted using an MSSAB 506 and a CAB 508 from the features extracted by the stacked convolutional layers 502 and 504. Parallel convolution with different receptive fields may be beneficial when extracting features with various receptive fields. To increase the receptive field and capture multi-scale and depth information, while reducing network parameters, LMSDAB 500 may be designed with three parts, e.g., namely, a feature extraction portion, a feature fusion portion, and an attention enhancement portion.

The feature extraction part contains one 1×1 convolution layer 504 and three 3×3 convolution layers 502. The feature fusion portion may use a concatenator 514 to concatenate features in the channel dimension and uses a 1×1 convolution layer 504 for fusion and dimension reduction. The attention enhancement portion uses MSSAB 506 and CAB 508 to enhance the fused features in both spatial and channel dimensions. Note that each convolutional layer 502, 504 is followed by a ReLU activation function to improve the performance of the network. For instance, ReLU activation function performs nonlinear mapping with a high degree of accuracy, solves the gradient disappearance problem in the neural network, and reduces network convergence latency. The overall operations performed by LMSDAB 500 are described below.

For instance, the feature extraction section may be used to extract scale and depth features. The feature extractor is based on 1×1 convolutional layer 504 and 3×3 convolutional layer 502. The larger scale features are obtained by another 3×3 convolution layer 502 with the output of the 3×3 convolutional layer 502 of the previous stage used as an input to the following stage. The features extracted from the feature extraction portion are stitched together on the channel dimension. Then, a fused feature map is generated by fusing the extracted features through a 1×1 convolution layer 504, which reduces the number of dimensions and computational complexity. The attention enhancement portion obtains three branches from the feature extraction portion using MSSAB 506 as input to obtain multi-scale spatial attention map. The multi-scale spatial attention map may be generated by pixel-wise multiplication 510 with the fused feature map. Then, the output feature maps of channel attention enhancement are obtained by CAB 508. Finally, the input of LMSDAB 500 and the output of CAB 508 may be combined using pixel-wise addition 512.

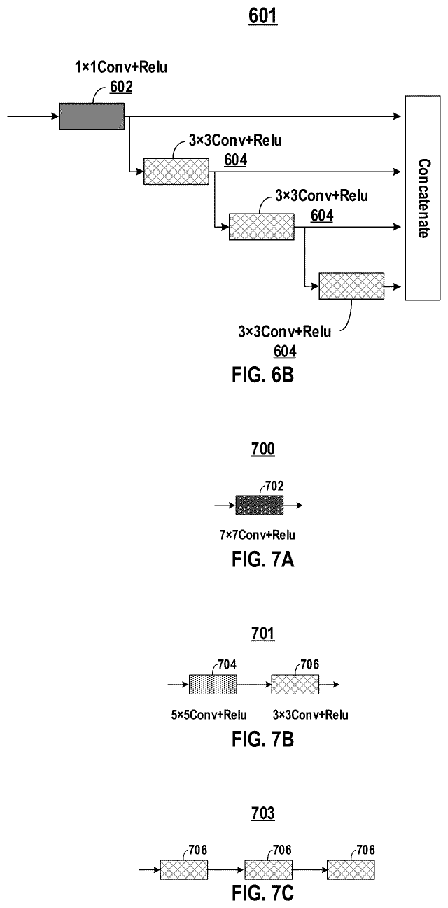

FIG. 6A illustrates an example multi-scale feature extraction component 600. FIG. 6B illustrates an exemplary multi-scale feature extraction component 601, according to some embodiments of the present disclosure. FIGS. 6A and 6B will be described together.

Referring to FIG. 6A, the architecture of an example multi-scale feature extraction component 600 for extracting multi-scale feature information is shown. Example multi-scale feature extraction component 600 may include, e.g., a 1×1 convolutional/ReLU layer 602, two 3×3 convolutional/ReLU layers 604, and two 5×5 convolutional/ReLU layers 606. This architecture includes four branches, and each branch independently extracts different scale information without interfering with each other. As the layer deepens from top to bottom, the size and number of convolution kernels increases. Consequently, the number of parameters associated with the architecture depicted in FIG. 6A may be unduly large, thereby leading to undesirable computational complexity and network latency. The number of parameters associated with this existing structure may be unduly large and redundant, thereby leading to undesirable computational complexity and network latency.

On the other hand, FIG. 6B depicts the architecture of an exemplary multi-scale feature extraction component 601 with shared convolution for multi-scale feature extraction, which includes one 1×1 convolutional/ReLU layer 602 and three 3×3 convolutional/ReLU layers 604. One advantage of the architecture depicted in FIG. 6B is that the depth information of convolutional layers is considered while the multiple scale information is obtained. Using the architecture shown in FIG. 6B, larger scale features may be obtained by a 3×3 convolutional/ReLU layer 604 with the 3×3 output of the previous stage as input, thereby reducing the number of parameters by sharing the convolutional/ReLU layers 604 without decreasing the performance. This is because, in the convolution operation, the receptive field of a large convolution kernel is obtained by two or more convolutional cascades, as depicted in FIGS. 7A-7C.

Furthermore, exemplary multi-scale feature extraction component 601 generates deep feature information. In the cascade CNNs, different network depths can produce different feature information. That is, shallower network layers produce low-level information, such as rich textures and edges, while deeper network layers can extract high-level semantic information, such as contours. The exemplary LMSDAB not only extracts scale information, but also obtains depth information in different depth convolutions. Thus, the LMSDAB extracts scale information with deep feature information, which generates rich feature extraction for SR.

FIG. 7A illustrates a first exemplary convolutional model 700, according to some aspects of the present disclosure. FIG. 7B illustrates a second exemplary convolutional model 701, according to some aspects of the present disclosure. FIG. 7C illustrates a third exemplary convolutional model 703, according to some aspects of the present disclosure. FIGS. 7A-7C will be described together.

Referring to FIGS. 7A-7C, the receptive field of a kernel of a 7×7 convolutional/ReLU layer 702 is 7×7, which is equivalent to the receptive field obtained by cascading one 5×5 convolutional/ReLU layer 704 and 3×3 convolutional/ReLU layer 706 (as shown in FIG. 7B) or three 3×3 convolutional/ReLU layers 706 (as shown in FIG. 7C).

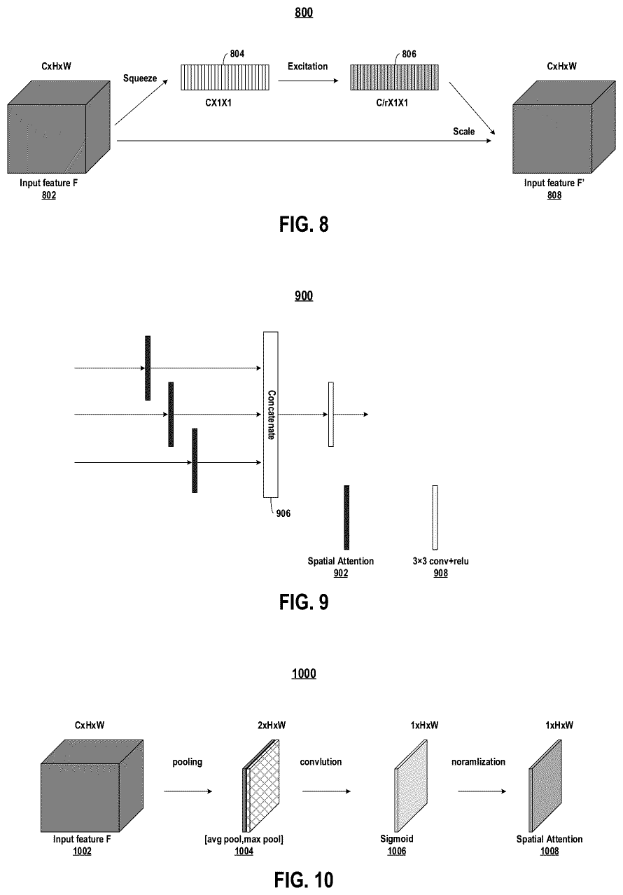

FIG. 8 illustrates a detailed block diagram of an exemplary CAB 800 (referred to hereinafter as “CAB 800”), according to some aspects of the present disclosure.

In conventional convolution calculations, each output channel corresponds to a separate convolution kernel, and these convolution kernels are independent of each other. In other words, the output channels do not fully consider the correlation between input channels. CAB 800 may be included in the LMSDAB to solve/improve this problem. The operations performed by CAB 800 may be considered in three steps, e.g., namely, squeezing, excitation, and scaling.

With respect to CAB's 800 squeezing operation, global average pooling is performed on the input feature map F 802 to obtain ƒ_{sq}. For example, CAB 800 first squeezes global spatial information into a channel descriptor. This is achieved by global average pooling to generate channel-wise statistics. CAB 800 may perform excitation to better obtain the dependency of each channel. Two conditions need to be met during excitation. The first is that the nonlinear relationship between each channel can be learned, and the second is to ensure that each channel has a non-zero output. Thus, the activation function here is sigmoid instead of the commonly used ReLU. The excitation process is that ƒ_{sq} passes through two fully connected layers to compress and restore the channel. In image processing, to avoid the conversion between matrices and vectors, a 1×1 convolutional layer 804 is used instead of the fully connected layer. Finally, CAB 800 performs scaling using a dot product (e.g., C/r×1×1 convolutional layer 806) to generate an enhanced input feature map F′ 808.

FIG. 9 illustrates a detailed block diagram of an exemplary MSSAB 900, according to some aspects of the present disclosure.

Referring to FIG. 9, MSSAB is made up of three spatial attention blocks (SABs) 902, a connection layer 906, and a convolutional layer 908. The input of three SABs 902 is the output of three branches of the feature extraction portion of the LMSDAB, and each proposed feature is subject to a spatial attention operation. Then, three spatial attention maps are concatenated together at connection layer 906, and go through a 3×3 convolutional layer 908 for fusion to obtain the final multi-scale spatial attention map.

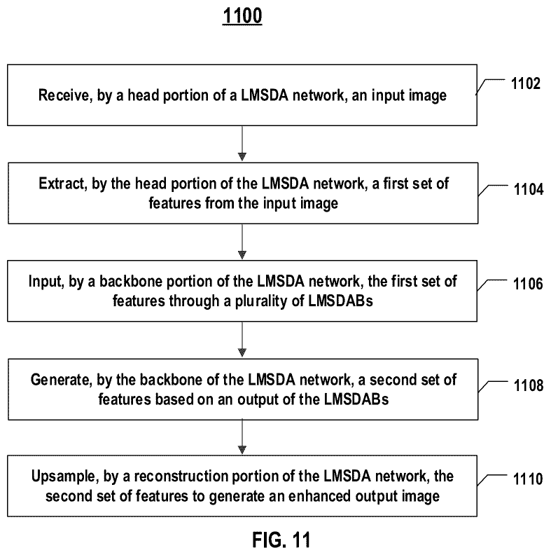

FIG. 10 illustrates a detailed block diagram of an exemplary SAB 1000, according to some aspects of the present disclosure. Referring to FIG. 10, the operations performed by SAB 1000 include, e.g., pooling, convolution, and normalization. To begin, SAB 1000 may perform average pooling and maximum pooling on the input feature map F 1002 to obtain two 1×H×W feature maps 1004 to reflect spatial information, e.g., the average information and maximum information. Then, SAB 1000 may connect the two feature maps 1004 and use a convolutional layer to fuse the average information and the maximum information to generate a spatial information map with 1 channel number. Then, the feature map obtained in the second step is sent through a sigmoid activation function 1006 to normalize the value of the feature map to 0˜1 as the weight of the corresponding position of the input feature map 1002 to generate a spatial attention map 1008.

To train the exemplary LMSDA network, an L2 loss, which is convenient for gradient descent. When the error is large, it decreases quickly, and when the error is small, it decreases slowly, which is conducive to convergence. The loss function ƒ(x) may be represented by expression (6).

$$f ( x ) = L 2. \qquad ( 6 )$$

FIG. 11 illustrates a flow chart of an exemplary method 1100 of video encoding, according to some embodiments of the present disclosure. Method 1100 may be performed by an apparatus, e.g., such as encoder 101, LMSDA network 300, 400, or any other suitable video encoding and/or compression systems. Method 1100 may include operations 1102-1110 as described below. It is understood that some of the operations may be optional, and some of the operations may be performed simultaneously, or in a different order other than shown in FIG. 11.

Referring to FIG. 11, at 1102, the apparatus may receive, by a head portion of an LMSDA network, an input image. For example, referring to FIG. 3, head portion of LMSDA network 300 receives an input image 302.

At 1104, the apparatus may extract, by the head portion of the LMSDA network, a first set of features from the input image. For example, referring to FIG. 3, head portion 301 includes a convolutional layer 304, which is used to extract the shallow features of the input image 302. Convolutional layer 304 in head portion 301 is followed by a rectified linear activation function (ReLU) activation function (not shown). Given input Y_{LR}, through the head network ψ, the shallow feature ƒ₀ is obtained according to expression (1), shown above.

At 1106, the apparatus may input, by a backbone portion of the LMSDA network, the first set of features through a plurality of LMSDABs. For example, referring to FIG. 3, shallow feature ƒ₀ (e.g., the first set of features) may be received as the input to backbone portion 303.

At 1108, the apparatus may generate, by the backbone portion of the LMSDA network, a second set of features based on an output of the LMSDABs. For example, referring to FIG. 3, backbone portion 303 may include M LMSDABs 306. Backbone portion 303 uses ƒ₀ as input. A concatenator 310 concatenates the LMSDAB outputs, and finally reduces the number of channels by a 1×1 convolutional layer 312 to obtain ƒ_{ft} (e.g., the second set of features) according to expression (3), shown above. ƒ_{ft} may be used as the input into reconstruction portion 305. To take advantage of low-level features, backbone portion 303 uses the connection method in the U-Net to add ƒᵢ and ƒ_{M-i} as the input of ω_{M-i+1} according to expression (2).

At 1110, the apparatus may upsample, by a reconstruction portion of the LMSDA network, the second set of features to generate an enhanced output image. For example, referring to FIG. 3, reconstruction portion 305 (e.g., the upsampling network) includes one convolutional layer 304 and a pixel shuffle layer 316. The upsampling network may be represented according to expression (4), shown above. In addition to the three parts, the input image may be directly added to the output by upsampling the input via upsampling bicubic component 308. In this way, LMSDA network 300 only needs to learn the global residual information to enhance the quality of the output image 318, which reduces the training and computational complexity.

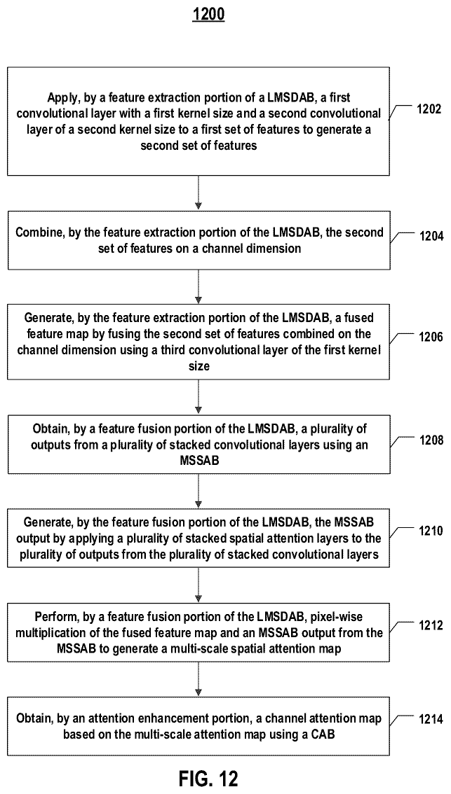

FIG. 12 illustrates a flow chart of an exemplary method 1200 of video encoding, according to some embodiments of the present disclosure. Method 1200 may be performed by an apparatus, e.g., LMSDAB 500 or any other suitable video encoding and/or compression systems. Method 1200 may include operations 1202-1214 as described below. It is understood that some of the operations may be optional, and some of the operations may be performed simultaneously, or in a different order other than shown in FIG. 12.

Referring to FIG. 12, at 1202, the apparatus may apply, by a feature extraction portion of an LMSDAB, a first convolutional layer with a first kernel size and a second convolutional layer of a second kernel size to a first set of features to generate a second set of features. For example, referring to FIG. 5, LMSDAB 500 may extract multi-scale and depth features from a large receptive field using stacked convolutional layers 502, 504.

At 1204, the apparatus may combine, by the feature extraction portion of the LMSDAB, the second set of features on a channel dimension. For example, referring to FIG. 4, feature fusion portion may use a concatenator 514 to concatenate features in the channel dimension.

At 1206, the apparatus may generate, by the feature extraction portion of the LMSDAB, a fused feature map by fusing the second set of features combined on the channel dimension using a third convolutional layer of the first kernel size. For example, referring to FIG. 5, feature fusion portion may use a 1×1 convolution layer 504 for fusion and dimension reduction.

At 1208, the apparatus may obtain, by a feature fusion portion of the LMSDAB, a plurality of outputs from a plurality of stacked convolutional layers using an MSSAB. For example, referring to FIG. 5, the attention enhancement portion obtains three branches from the feature extraction portion using MSSAB 506 as input

At 1210, the apparatus may generate, by the feature fusion portion of the LMSDAB, the MSSAB output by applying a plurality of stacked spatial attention layers to the plurality of outputs from the plurality of stacked convolutional layers. For example, referring to FIG. 5, the attention enhancement portion obtains three branches from the feature extraction portion using MSSAB 506 as input to obtain multi-scale spatial attention map.

At 1212, the apparatus may perform, by a feature fusion portion of the LMSDAB, pixel-wise multiplication of the fused feature map and an MSSAB output from the MSSAB to generate a multi-scale spatial attention map. For example, referring to FIG. 5, the multi-scale spatial attention map may be generated by pixel-wise multiplication 510 with the fused feature map.

At 1214, the apparatus may obtain, by an attention enhancement portion, a channel attention map based on the multi-scale spatial attention map using a CAB. For example, referring to FIG. 5, the output feature maps (e.g., channel attention maps) of channel attention enhancement are obtained by CAB 508.

In various aspects of the present disclosure, the functions described herein may be implemented in hardware, software, firmware, or any combination thereof. If implemented in software, the functions may be stored as instructions on a non-transitory computer-readable medium. Computer-readable media includes computer storage media. Storage media may be any available media that can be accessed by a processor, such as processor 102 in FIGS. 1 and 2. By way of example, and not limitation, such computer-readable media can include RAM, ROM, EEPROM, CD-ROM or other optical disk storage, HDD, such as magnetic disk storage or other magnetic storage devices, Flash drive, SSD, or any other medium that can be used to carry or store desired program code in the form of instructions or data structures and that can be accessed by a processing system, such as a mobile device or a computer. Disk and disc, as used herein, includes CD, laser disc, optical disc, digital video disc (DVD), and floppy disk where disks usually reproduce data magnetically, while discs reproduce data optically with lasers. Combinations of the above should also be included within the scope of computer-readable media.

According to one aspect of the present disclosure, a method of video encoding is provided. The method may include receiving, by a head portion of a LMSDA network, an input image. The method may include extracting, by the head portion of the LMSDA network, a first set of features from the input image. The method may include inputting, by a backbone portion of the LMSDA network, the first set of features through a plurality of LMSDABs. The method may include generating, by the backbone portion of the LMSDA network, a second set of features based on an output of the LMSDABs. The method may include upsampling, by a reconstruction portion of the LMSDA network, the second set of features to generate an enhanced output image.

In some embodiments, the LMSDA network may be associated with a luma channel or a chroma channel.

In some embodiments, the generating, by the backbone portion of the LMSDA network, the second set of features based on the output of the LMSDABs may include applying a first convolutional layer with a first kernel size and a second convolutional layer of a second kernel size to the first set of features to generate a third set of features. In some embodiments, the generating, by the backbone portion of the LMSDA network, the second set of features based on the output of the LMSDABs may include combining the third set of features on a channel dimension. In some embodiments, the generating, by the backbone portion of the LMSDA network, the second set of features based on the output of the LMSDABs may include generating a fused feature map by fusing the third set of features combined on the channel dimension using a third convolutional layer of the first kernel size.

In some embodiments, the generating, by the backbone portion of the LMSDA network, the second set of features based on the output of the LMSDABs may include obtaining a plurality of outputs from a plurality of stacked convolutional layers using an MSSAB. In some embodiments, the generating, by the backbone portion of the LMSDA network, the second set of features based on the output of the LMSDABs may include performing pixel-wise multiplication of the fused feature map and an MSSAB output from the MSSAB to generate a multi-scale spatial attention feature map

In some embodiments, the generating, by the backbone portion of the LMSDA network, the second set of features based on the output of the LMSDABs may include generating the MSSAB output by applying a plurality of stacked spatial attention layers to the plurality of outputs from the plurality of stacked convolutional layers.

In some embodiments, the generating, by the backbone portion of the LMSDA network, the second set of features based on the output of the LMSDABs may include obtaining a channel attention map based on the multi-scale spatial attention map using a CAB.

In some embodiments, the enhanced output image may be generated based at least in part on the multi-scale spatial attention map and the channel attention map.

According to another aspect of the present disclosure, a system for video encoding is provided. The system may include a memory configured to store instructions. The system may include a processor coupled to the memory and configured to, upon executing the instructions, receive, by a head portion of an LMSDA network, an input image. The system may include a processor coupled to the memory and configured to, upon executing the instructions, extract, by the head portion of the LMSDA network, a first set of features from the input image. The system may include a processor coupled to the memory and configured to, upon executing the instructions, input, by a backbone portion of the LMSDA network, the first set of features through a plurality of LMSDABs. The system may include a processor coupled to the memory and configured to, upon executing the instructions, generate, by the backbone portion of the LMSDA network, a second set of features based on an output of the LMSDABs. The system may include a processor coupled to the memory and configured to, upon executing the instructions, upsample, by a reconstruction portion of the LMSDA network, the second set of features to generate an enhanced output image.

In some embodiments, the LMSDA network may be associated with a luma channel or a chroma channel.

In some embodiments, the processor coupled to the memory may be configured to, upon executing the instructions, generate, by the backbone portion of the LMSDA network, the second set of features based on the output of the LMSDABs by applying a first convolutional layer with a first kernel size and a second convolutional layer of a second kernel size to the first set of features to generate a third set of features. In some embodiments, the processor coupled to the memory may be configured to, upon executing the instructions, generate, by the backbone portion of the LMSDA network, the second set of features based on the output of the LMSDABs by combining the third set of features on a channel dimension. In some embodiments, the processor coupled to the memory may be configured to, upon executing the instructions, generate, by the backbone portion of the LMSDA network, the second set of features based on the output of the LMSDABs by generating a fused feature map by fusing the third set of features combined on the channel dimension using a third convolutional layer of the first kernel size.

In some embodiments, the processor coupled to the memory may be configured to, upon executing the instructions, generate, by the backbone portion of the LMSDA network, the second set of features based on the output of the LMSDABs by obtaining a plurality of outputs from a plurality of stacked convolutional layers using an MSSAB. In some embodiments, the processor coupled to the memory may be configured to, upon executing the instructions, generate, by the backbone portion of the LMSDA network, the second set of features based on the output of the LMSDABs by performing pixel-wise multiplication of the fused feature map and an MSSAB output from the MSSAB to generate a multi-scale spatial attention feature map.

In some embodiments, the processor coupled to the memory may be configured to, upon executing the instructions, generate, by the backbone portion of the LMSDA network, the second set of features based on the output of the LMSDABs by generating the MSSAB output by applying a plurality of stacked spatial attention layers to the plurality of outputs from the plurality of stacked convolutional layers.

In some embodiments, the processor coupled to the memory may be configured to, upon executing the instructions, generate, by the backbone portion of the LMSDA network, the second set of features based on the output of the LMSDABs by obtaining a channel attention map based on the multi-scale spatial attention map using a CAB.

In some embodiments, the enhanced output image may be generated based at least in part on the multi-scale spatial attention map and the channel attention map.

According to a further aspect of the present disclosure, a method of video encoding is provided. The method may include applying, by a feature extraction portion of an LMSDAB, a first convolutional layer with a first kernel size and a second convolutional layer of a second kernel size to a first set of features to generate a second set of features. The method may include combining, by the feature extraction portion of the LMSDAB, the second set of features on a channel dimension. The method may include generating, by the feature extraction portion of the LMSDAB, a fused feature map by fusing the second set of features combined on the channel dimension using a third convolutional layer of the first kernel size.

In some embodiments, the method may include obtaining, by a feature fusion portion of the LMSDAB, a plurality of outputs from a plurality of stacked convolutional layers using an MSSAB. In some embodiments, the method may include generating, by the feature fusion portion of the LMSDAB, the MSSAB output by applying a plurality of stacked spatial attention layers to the plurality of outputs from the plurality of stacked convolutional layers. In some embodiments, the method may include performing, by a feature fusion portion of the LMSDAB, pixel-wise multiplication of the fused feature map and an MSSAB output from the MSSAB to a multi-scale spatial attention feature map.

In some embodiments, the method may include obtaining, by an attention enhancement portion, a channel attention map based on the multi-scale spatial attention map using a CAB.

According to yet another aspect of the present disclosure, a system for video encoding is provided. The system may include a memory configured to store instructions. The system may include a processor coupled to the memory and configured to, upon executing the instructions, apply, by a feature extraction portion of an LMSDAB, a first convolutional layer with a first kernel size and a second convolutional layer of a second kernel size to a first set of features to generate a second set of features. The system may include a processor coupled to the memory and configured to, upon executing the instructions, combine, by the feature extraction portion of the LMSDAB, the second set of features on a channel dimension. The system may include a processor coupled to the memory and configured to, upon executing the instructions, generate, by the feature extraction portion of the LMSDAB, a fused feature map by fusing the second set of features combined on the channel dimension using a third convolutional layer of the first kernel size.

In some embodiments, the processor coupled to the memory may be further configured to, upon executing the instructions, obtain, by a feature fusion portion of the LMSDAB, a plurality of outputs from a plurality of stacked convolutional layers using an MSSAB. In some embodiments, the processor coupled to the memory may be further configured to, upon executing the instructions, generate, by the feature fusion portion of the LMSDAB, the MSSAB output by applying a plurality of stacked spatial attention layers to the plurality of outputs from the plurality of stacked convolutional layers. In some embodiments, the processor coupled to the memory may be further configured to, upon executing the instructions, perform, by a feature fusion portion of the LMSDAB, pixel-wise multiplication of the fused feature map and an MSSAB output from the MSSAB to generate a multi-scale spatial attention feature map.

In some embodiments, the processor coupled to the memory may be further configured to, upon executing the instructions, obtain, by an attention enhancement portion, a channel attention map based on the multi-scale spatial attention map using a CAB.

The foregoing description of the embodiments will so reveal the general nature of the present disclosure that others can, by applying knowledge within the skill of the art, readily modify and/or adapt for various applications such embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all exemplary embodiments of the present disclosure as contemplated by the inventor(s), and thus, are not intended to limit the present disclosure and the appended claims in any way.

Various functional blocks, modules, and steps are disclosed above. The arrangements provided are illustrative and without limitation. Accordingly, the functional blocks, modules, and steps may be reordered or combined in different ways than in the examples provided above. Likewise, some embodiments include only a subset of the functional blocks, modules, and steps, and any such subset is permitted.

The breadth and scope of the present disclosure should not be limited by any of the above-described exemplary embodiments, but should be defined only in accordance with the following claims and their equivalents.

What is claimed is:

1. A method of video encoding, comprising:
receiving, by a head portion of a lightweight multi-level mixed scale and depth information with attention mechanism (LMSDA) network, an input image;
extracting, by the head portion of the LMSDA network, a first set of features from the input image;
inputting, by a backbone portion of the LMSDA network, the first set of features through a plurality of LMSDA blocks (LMSDABs);
generating, by the backbone portion of the LMSDA network, a second set of features based on an output of the LMSDABs; and
upsampling, by a reconstruction portion of the LMSDA network, the second set of features to generate an enhanced output image.

2. The method of claim 1, wherein the LMSDA network is associated with a luma channel or a chroma channel.

3. The method of claim 1, wherein the generating, by the backbone portion of the LMSDA network, the second set of features based on the output of the LMSDABs comprises:
applying a first convolutional layer with a first kernel size and a second convolutional layer of a second kernel size to the first set of features to generate a third set of features;
combining the third set of features on a channel dimension; and
generating a fused feature map by fusing the third set of features combined on the channel dimension using a third convolutional layer of the first kernel size.

4. The method of claim 3, wherein the generating, by the backbone portion of the LMSDA network, the second set of features based on the output of the LMSDABs comprises:
obtaining a plurality of outputs from a plurality of stacked convolutional layers using a multi-scale spatial attention block (MSSAB); and
performing pixel-wise multiplication of the fused feature map and an MSSAB output from the MSSAB to generate a multi-scale spatial attention feature map.

5. The method of claim 4, wherein the generating, by the backbone portion of the LMSDA network, the second set of features based on the output of the LMSDABs comprises:
generating the MSSAB output by applying a plurality of stacked spatial attention layers to the plurality of outputs from the plurality of stacked convolutional layers.

6. The method of claim 4, wherein the generating, by the backbone portion of the LMSDA network, the second set of features based on the output of the LMSDABs comprises:
obtaining a channel attention map based on the multi-scale spatial attention feature map using a channel attention block (CAB).

7. The method of claim 6, wherein the enhanced output image is generated based at least in part on the multi-scale spatial attention feature map and the channel attention map.

8. A system for video encoding, comprising:
a memory configured to store instructions; and
a processor coupled to the memory and configured to, upon executing the instructions:
receive, by a head portion of a lightweight multi-level mixed scale and depth information with attention mechanism (LMSDA) network, an input image;
extract, by the head portion of the LMSDA network, a first set of features from the input image;
input, by a backbone portion of the LMSDA network, the first set of features through a plurality of LMSDA blocks (LMSDABs);
generate, by the backbone portion of the LMSDA network, a second set of features based on an output of the LMSDABs; and
upsample, by a reconstruction portion of the LMSDA network, the second set of features to generate an enhanced output image.

9. The system of claim 8, wherein the LMSDA network is associated with a luma channel or a chroma channel.

10. The system of claim 8, wherein the processor coupled to the memory and configured to, upon executing the instructions, generate, by the backbone portion of the LMSDA network, the second set of features based on the output of the LMSDABs by:
applying a first convolutional layer with a first kernel size and a second convolutional layer of a second kernel size to the first set of features to generate a third set of features;
combining the third set of features on a channel dimension; and
generating a fused feature map by fusing the third set of features combined on the channel dimension using a third convolutional layer of the first kernel size.

11. The system of claim 10, wherein the processor coupled to the memory and configured to, upon executing the instructions, generate, by the backbone portion of the LMSDA network, the second set of features based on the output of the LMSDABs by:
obtaining a plurality of outputs from a plurality of stacked convolutional layers using a multi-scale spatial attention block (MSSAB); and
performing pixel-wise multiplication of the fused feature map and an MSSAB output from the MSSAB to generate a multi-scale spatial attention feature map.

12. The system of claim 11, wherein the processor coupled to the memory and configured to, upon executing the instructions, generate, by the backbone portion of the LMSDA network, the second set of features based on the output of the LMSDABs by:
generating the MSSAB output by applying a plurality of stacked spatial attention layers to the plurality of outputs from the plurality of stacked convolutional layers.

13. The system of claim 11, wherein the processor coupled to the memory and configured to, upon executing the instructions, generate, by the backbone portion of the LMSDA network, the second set of features based on the output of the LMSDABs by:
obtaining a channel attention map based on the multi-scale spatial attention feature map using a channel attention block (CAB).

14. The system of claim 13, wherein the enhanced output image is generated based at least in part on the multi-scale spatial attention feature map and the channel attention map.

15. A method of video encoding, comprising:
applying, by a feature extraction portion of a lightweight multi-level mixed scale and depth information with attention mechanism block (LMSDAB), a first convolutional layer with a first kernel size and a second convolutional layer of a second kernel size to a first set of features to generate a second set of features;
combining, by the feature extraction portion of the LMSDAB, the second set of features on a channel dimension; and
generating, by the feature extraction portion of the LMSDAB, a fused feature map by fusing the second set of features combined on the channel dimension using a third convolutional layer of the first kernel size.

16. The method of claim 15, further comprising:
obtaining, by a feature fusion portion of the LMSDAB, a plurality of outputs from a plurality of stacked convolutional layers using a multi-scale spatial attention block (MSSAB);
generating, by the feature fusion portion of the LMSDAB, an MSSAB output by applying a plurality of stacked spatial attention layers to the plurality of outputs from the plurality of stacked convolutional layers; and
performing, by the feature fusion portion of the LMSDAB, pixel-wise multiplication of the fused feature map and the MSSAB output from the MSSAB to generate a multi-scale spatial attention feature map.

17. The method of claim 16, further comprises:
obtaining, by an attention enhancement portion, a channel attention map based on the multi-scale spatial attention feature map using a channel attention block (CAB).
